(19) United States
(12) Patent Application Publication
(10) Pub. No.: US 2026/0275920 A1
(43) Pub. Date: Sep. 17, 2026

(54) APPARATUS FOR SUPPORTING A COMPONENT

(71) Applicant: Rolls-Royce plc, London (GB)

(72) Inventors: Henry M J SIMKIN, Derby (GB); Wayne MILLER, Derby (GB)

(73) Assignee: ROLLS-ROYCE plc, London (GB)

(21) Appl. No.: 19/536,447

(22) Filed: Feb. 11, 2026

(30) Foreign Application Priority Data
Mar. 12, 2025 (GB) 2503581.7

(51) Int. Cl. F02C 7/36; F01D 9/04; F02C 9/18; F02K 3/06; F02K 3/075

(52) U.S. Cl. CPC F02C 7/36; F01D 9/041; F02C 9/18; F02K 3/06; F02K 3/075

(57) ABSTRACT

An apparatus for supporting a component to aid manufacturing, assembly, maintenance or repair operations. The apparatus includes a platform. The apparatus also includes a first support structure mounted on the platform and configured to support a first end of the component. The first support structure includes a first pedestal including a first pedestal body disposed on the platform. The first pedestal further includes a pair of first transverse members spaced apart from each other and extending from the first pedestal body towards a direction away from the platform. Each first transverse member from the pair of first transverse members includes at least two first openings. The first openings in the spaced apart first transverse members are aligned with each other.

### CROSS REFERENCE TO RELATED APPLICATIONS

This specification is based upon and claims the benefit of priority from United Kingdom patent application number GB 2503581.7 filed on March 12, 2025, the entire contents of which is incorporated herein by reference.

### BACKGROUND

### Technical Field

This disclosure relates to an apparatus for supporting a component to aid manufacturing, assembly, maintenance and/or repair operations.

### Description of the Related Art

Conventionally, a balancing machine is used to support a component for performing its manufacture, assembly, inspection and/or maintenance.

For example when the component is a gas turbine rotor of a gas turbine engine, the gas turbine rotor may be removed from the gas turbine casing and supported on the balancing machine so the gas turbine rotor may be inspected and any necessary maintenance carried out. Typically each end of the gas turbine rotor is supported on a roller of the balancing machine, which makes various parts of the gas turbine rotor such as rotor blades readily accessible for servicing. These rollers support the gas turbine rotor whilst allowing the gas turbine rotor to be rotated as needed.

Such rollers, however, are typically short in axial length and cantilevered from a single support structure. This tends to lead to a roller axle bending or deforming under heavy loading. Due to this bending, the rollers may not maintain optimal contact with the component being inspected, thereby compromising the inspection or maintenance process.

Additionally, rollers of conventional balancing machines generally incorporate internal bearings and the bearing size is constrained by the internal dimensions of the roller. Since the bearing must fit inside the roller, the axle diameter is also limited by the available bearing dimensions, restricting the overall strength and rigidity of the support structure. Furthermore, the roller diameter of current balancing machines cannot be smaller than the outer diameter of the bearings, which may further limit flexibility in designing rollers to suit different sizes.

Therefore, there is a need for an improved support apparatus or balancing stand which addresses above-mentioned limitations and enables efficient maintenance and inspection of the component or at least provides a useful to known balancing machines.

### SUMMARY

According to a first aspect, an apparatus for supporting a component to aid manufacturing, assembly, maintenance or repair operations is provided. The component has a first end and a second end opposite to the first end. The apparatus includes a platform. The apparatus further includes a first support structure mounted on the platform and configured to support the first end of the component. The first support structure includes a first pedestal including a first pedestal body disposed on the platform. The first pedestal further includes a pair of first transverse members spaced apart from each other and extending from the first pedestal body towards a direction away from the platform. Each first transverse member from the pair of first transverse members includes at least two first openings. The first openings in the spaced apart first transverse members are aligned with each other. The first support structure further includes at least two first axles. Each first axle passes and extends through the corresponding two first openings aligned with each other, such that each opposing end of each first axle is supported by one first transverse member from the pair of first transverse members. The first support structure further includes at least two first rollers spaced apart from each other and configured to support the first end of the component. Each first roller is mounted on the corresponding first axle. Each first roller is positioned between the pair of first transverse members of the first pedestal. The apparatus further includes a second support structure mounted on the platform and configured to support the second end of the component. The second support structure is spaced apart from the first support structure. The second support structure includes a second pedestal including a second pedestal body disposed on the platform. The second pedestal further includes a pair of second transverse members spaced apart from each other and extending from the second pedestal body towards the direction away from the platform. Each second transverse member from the pair of second transverse members includes at least two second openings. The second openings in the spaced apart second transverse members are aligned with each other. The second support structure further includes at least two second axles. Each second axle passes and extends through the corresponding two second openings aligned with each other, such that each opposing end of each second axle is supported by one second transverse member from the pair of second transverse members. The second support structure further includes at least two second rollers spaced apart from each other and configured to support the second end of the component. Each second roller is mounted on the corresponding second axle. Each second roller is positioned between the pair of second transverse members of the second pedestal. Each opposing end of each first axle is rotatably supported by at least one first bearing. The at least one first bearing is disposed in the corresponding first opening from the at least two first openings of each first transverse member.

By supporting each opposing end of the at least two first axles on the pair of first transverse members, load is evenly distributed across each first axle from the at least two first axles. Further, by supporting each opposing end of the at least two second axles on the pair of second transverse members, load is evenly distributed across each second axle from the at least two second axles. With such even distribution of load across the at least two first axles and across the at least two second axles, the axles of the apparatus of the present disclosure may be subjected to significantly minimal bending under heavy loads. The relatively reduced bending of the at least two first axles and the at least two second axles may ensure consistent and optimal contact between the component and the at least two first rollers, and further between the component and the at least two second rollers. Hence, the apparatus of the present disclosure may provide a balancing stand for improved and effective maintenance, repair, and inspection of a component.

Disposal of the at least one first bearing in each first transverse member may allow for larger and more robust bearings. This may not only enhance durability but also allow for an increased diameter of the at least two first axles, thereby improving overall rigidity and strength of the apparatus of the present disclosure. Additionally, separation of the at least one first bearing from the corresponding first roller may provide greater flexibility in designing first rollers of varying sizes.

In some embodiments, each opposing end of each second axle is rotatably supported by at least one second bearing. The at least one second bearing is disposed in the corresponding second opening from the at least two second openings of each second transverse member. Disposal of the at least one second bearing in each second transverse member may allow for larger and more robust bearings. This may not only enhance durability but also allow for an increased diameter of the at least two second axles, thereby improving overall rigidity and strength of the apparatus of the present disclosure. Additionally, separation of the at least one second bearing from the corresponding second roller may provide greater flexibility in designing second rollers of varying sizes.

In some embodiments, each of the pair of first transverse members and the pair of second transverse members includes a curved portion and a pair of linear portions parallel to each other and extending from opposing ends of the curved portion. This allows precise mounting of cylindrical components (e.g., a rotor of a machine) on the apparatus of the present disclosure.

In some embodiments, the curved portion of each of the pair of first transverse members and the pair of second transverse members has a hemispherical shape. In other embodiments, the curved portion of each of the pair of first transverse members and the pair of second transverse members may have a different shape, such as torispherical, depending on application requirements.

In some embodiments, the curved portion of each of the pair of first transverse members and the pair of second transverse members has a semi-elliptical shape.

In some embodiments, each of the first pedestal and the second pedestal is U-shaped. In other embodiments, each of the first pedestal and the second pedestal may be V-shaped, or H-shaped, depending on application requirements.

In some embodiments, the pair of first transverse members defines a first cavity therebetween, such that the at least two first rollers extend at least partially within the first cavity. The at least two first rollers may be partially positioned inside the first cavity defined between the pair of first transverse members. Consequently, the at least two first axles upon which the at least two first rollers are mounted may be supported on either side by the pair of first transverse members, thereby distributing the load evenly across each first axle from the at least two first axles.

In some embodiments, the pair of second transverse members defines a second cavity therebetween, such that the at least two second rollers extend at least partially within the second cavity. The at least two second rollers may be partially positioned inside the second cavity defined between the pair of second transverse members. Consequently, the at least two second axles upon which the at least two second rollers are mounted may be supported on either side by the pair of second transverse members, thereby distributing the load evenly across each second axle from the at least two second axles.

In some embodiments, the at least two first axles and the at least two second axles are electrically powered. For example, the at least two first axles and the at least two second axles may be driven by an electric motor. The motor may be a three-phase driving type motor so as to be able to change rotation direction of the at least two first axles and the at least two second axles.

In some embodiments, one or both of the first pedestal and the second pedestal are selectively movable in order to vary a distance therebetween. The selective movement of the one or both of the first pedestal and the second pedestal may enable mounting of components of different lengths on the apparatus.

In some embodiments, the first pedestal and/or the second pedestal are electrically powered for selective movement thereof. For example, the first pedestal and the second pedestal may be driven by an electric motor or a stepper motor. Consequently, a rotational motion of the motor may be transformed into a linear motion to allow selective movement of the first pedestal and the second pedestal.

In some embodiments, the at least one first bearing is a thrust bearing. Such thrust bearing may be used to support axial load on the corresponding first axle.

In some embodiments, the at least one second bearing is a thrust bearing. Such thrust bearing may be used to support axial load on the corresponding first axle.

In some embodiments, a diameter of the at least two first rollers is larger than a diameter of each of the at least two first axles. This may ensure proper improved support for the component mounted on the at least two first rollers.

In some embodiments, a diameter of the at least two second rollers is larger than a diameter of the at least two second axles. This may ensure proper support for the component on the at least two second roller.

In some embodiments, the component is a component of a gas turbine engine. In other embodiments, the component may be any rotating component of a machine, for example, a crank shaft of an IC engine.

In some embodiments, the component is a rotor of the gas turbine engine. The component may be a turbine rotor or a compressor rotor of the gas turbine engine.

As noted elsewhere herein, the present disclosure may relate to the manufacture, assembly, inspection and repair of gas turbine engines and gas turbine engine components. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Such gas turbine engines may include those with fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only with reference to the accompanying drawings, in which:

FIG. 1 shows a schematic sectional side view of a gas turbine engine;

FIG. 2 is a schematic view of an apparatus for supporting a component, in accordance with an embodiment of the present disclosure;

FIG. 3A is a sectional view of the apparatus taken along a line A-A shown in FIG. 2, in accordance with an embodiment of the present disclosure;

FIG. 3B is a sectional view of the apparatus along a line B-B shown in FIG. 2;

FIG. 4A is a front view of the apparatus depicting a first support structure; and

FIG. 4B is a rear view of the apparatus depicting a second support structure.

### DETAILED DESCRIPTION

Aspects and embodiments of the present disclosure will now be discussed with reference to the accompanying Figures. Further aspects and embodiments will be apparent to those skilled in the art.

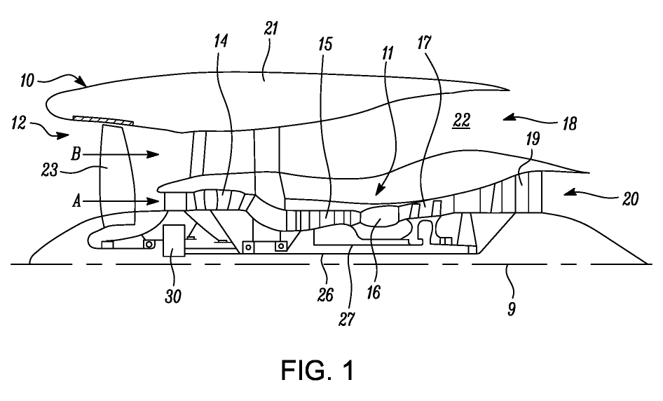

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high pressure compressor 15, combustion equipment 16, a high pressure turbine 17, a low pressure turbine 19, and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the core exhaust nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

Note that the terms “low pressure turbine” and “low pressure compressor” as used herein may be taken to mean the lowest pressure turbine stages and lowest pressure compressor stages (i.e., not including the fan 23) respectively and/or the turbine and compressor stages that are connected together by the interconnecting shaft 26 with the lowest rotational speed in the engine (i.e., not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

Other gas turbine engines to which the present disclosure may be applied may have alternative configurations. For example, such engines may have an alternative number of compressors and/or turbines and/or an alternative number of interconnecting shafts. By way of further example, the gas turbine engine 10 shown in FIG. 1 has a split flow nozzle 18, 20 meaning that the flow through the bypass duct 22 has its own nozzle 18 that is separate to and radially outside the core exhaust nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial, and circumferential directions are mutually perpendicular.

In addition, the present disclosure is equally applicable to aero gas turbine engines, marine gas turbine engines, and land-based gas turbine engines.

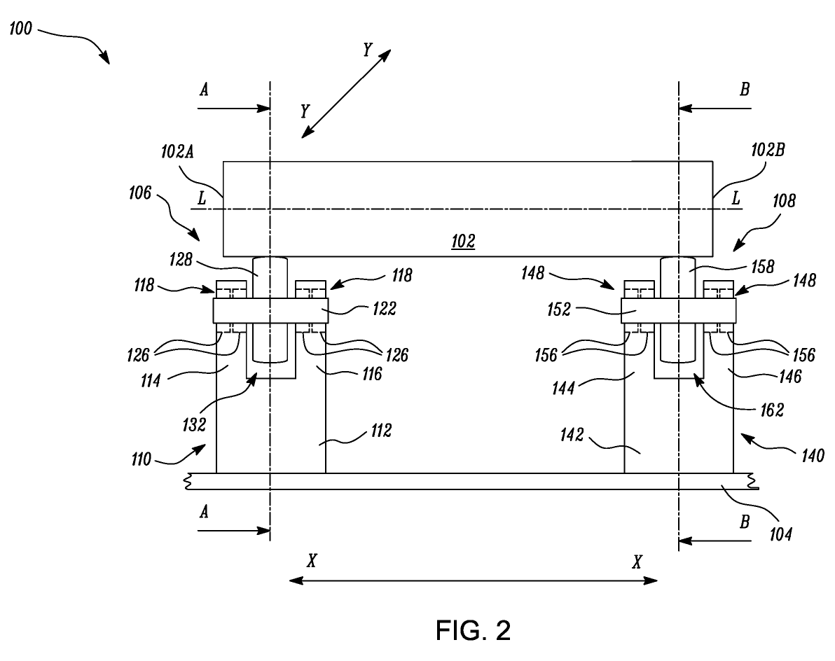

FIG. 2 is a schematic view of an apparatus 100 for supporting a component 102, according to an embodiment of the present disclosure. The apparatus 100 is used for supporting the component 102 to aid manufacturing, assembly, and repairing thereof. The apparatus 100 includes a platform 104 and a pair of support structures, for example a first support structure 106 and a second support structure 108, mounted on the platform 104. The second support structure 108 is spaced apart from the first support structure 106 in an axial direction (X-X). The first support structure 106 and the second support structure 108 are configured to support the component 102.

In some embodiments, the component 102 is a component of the gas turbine engine 10. In other embodiments, the component 102 may be any rotating component, for example, a crank shaft of an IC engine. In some embodiments, the component 102 is a rotor of the gas turbine engine 10. The component 102 may be a turbine rotor or a compressor rotor of the gas turbine engine 10.

The component 102 includes a first end 102A and a second end 102B opposite to the first end 102A. The first support structure 106 is configured to support the first end 102A of the component 102. The second support structure 108 is configured to support the second end 102B of the component 102. As shown, the component 102 is supported longitudinally on the first and second support structures 106, 108 such that a longitudinal axis (L-L) of the component 102 extends in the axial direction (X-X). In some embodiments, the first support structure 106 and the second support structure 108 are provided with a height adjusting unit (not shown) to maintain the horizontal position of the component 102 on the apparatus 100 in case of uneven ground surface or a difference in diameter of the shaft at either end.

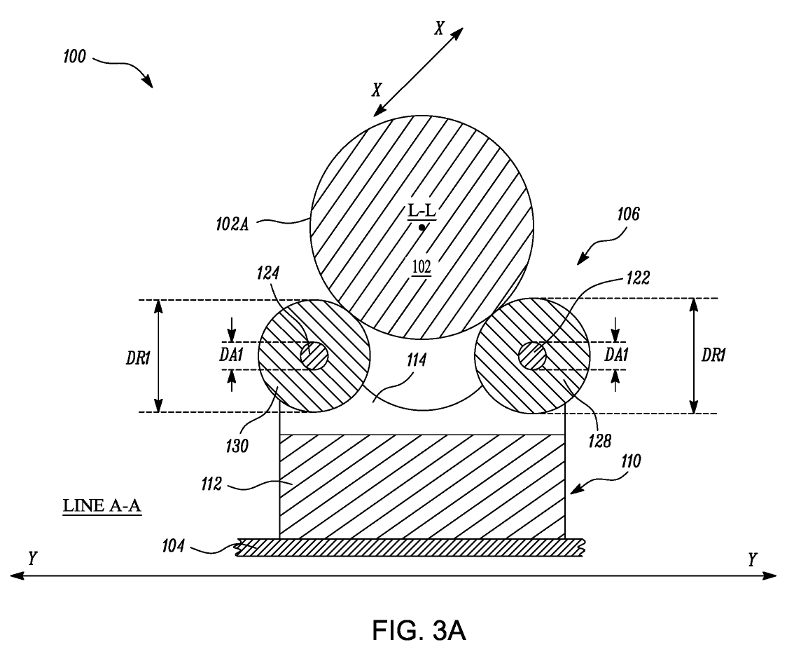

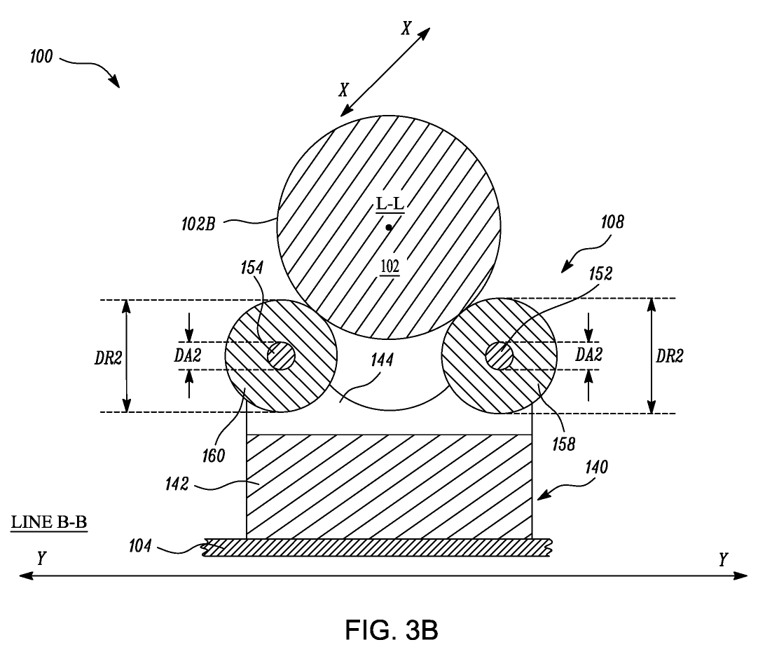

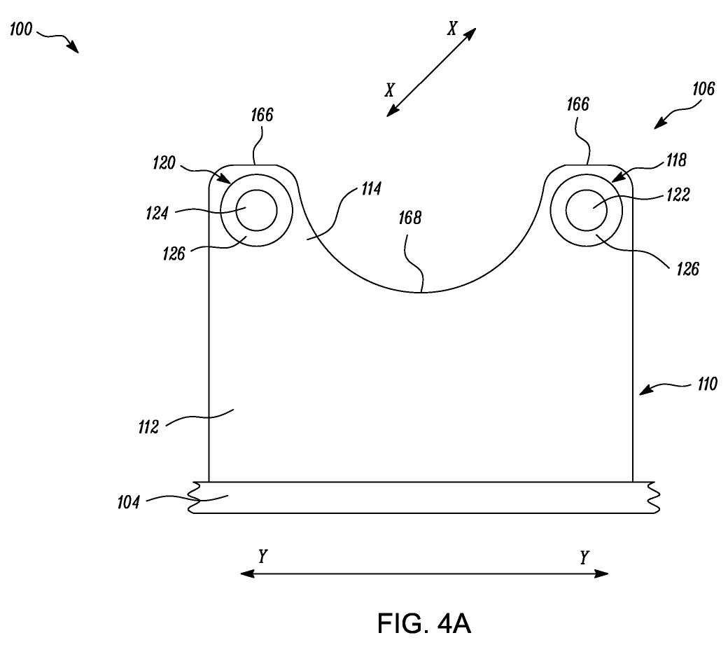

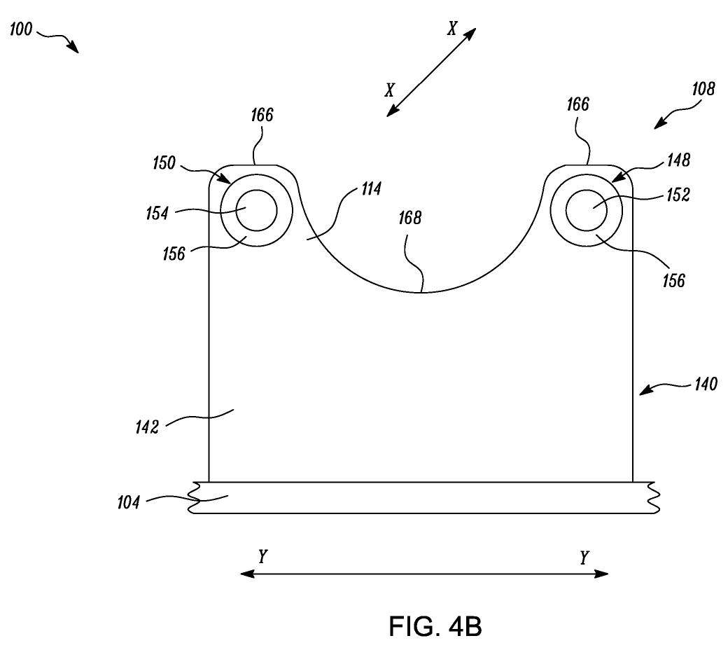

FIG. 3A is a sectional view of the apparatus 100 taken along a line A-A shown in FIG. 2, according to an embodiment of the present disclosure. Referring to FIGS. 2 and 3A, the first support structure 106 includes a first pedestal 110. The first pedestal 110 includes a first pedestal body 112 disposed on the platform 104. The first pedestal 110 further includes a pair of first transverse members 114, 116 (shown in FIG. 2) spaced apart from each other and extending from the first pedestal body 112 towards a direction away from the platform 104. Each first transverse member from the pair of first transverse members 114, 116 includes at least two first openings 118, 120 (shown in FIG. 4A). In the illustrated embodiment of FIGS. 2 and 3A, each first transverse member 114, 116 includes two first openings 118, 120 arranged linearly to each other in a transverse direction (Y-Y) perpendicular to the axial direction (X-X). The first transverse members 114, 116 are transverse with respect to the platform 104.

The first openings 118, 120 in the spaced apart first transverse members 114, 116 are aligned with each other. In other words, each first opening 118, 120 of one first transverse member (i.e., the first transverse member 114) is aligned with each first opening 118, 120 of another first transverse member (i.e., the first transverse member 116). The first support structure 106 further includes at least two first axles 122, 124 (shown in FIG. 3A). In the illustrated embodiment of FIGS. 2 and 3A, the first support structure 106 includes two first axles 122, 124 arranged parallel to each other in the transverse direction (Y-Y). Each first axle 122, 124 passes and extends through the corresponding two first openings 118, 120 aligned with each other, such that each opposing end of each first axle 122, 124 is supported by one first transverse member from the pair of first transverse members 114, 116. Bearings on each side of the roller do not need to be equally sized to allow for changes in the axle diameter.

Specifically, each opposing end of each first axle 122, 124 is rotatably supported by at least one first bearing 126. The at least one first bearing 126 is disposed in the corresponding first opening from the at least two first openings 118, 120 of each first transverse member 114, 116. In other words, a first end of each first axle 122, 124 is rotatably supported inside the corresponding first opening from the at least two first openings 118, 120 of corresponding first transverse member by the at least one first bearing 126. Similarly, an opposing second end of each first axle 122, 124 is rotatably supported inside the corresponding first opening from the at least two first openings 118, 120 of another first transverse member by another at least one first bearing 126.

In the illustrated embodiment of FIGS. 2 and 3A, each end of the first axles 122, 124 is rotatably supported inside the first openings 118, 120 of each first transverse member 114, 116 by a pair of first bearings 126. In some embodiments, each end of the first axles 122, 124 may be rotatably supported inside the first openings 118, 120 of each first transverse member 114, 116 by a single first bearing 126. In some embodiments, the at least one first bearing 126 is a thrust bearing.

The first support structure 106 further includes at least two first rollers 128, 130 (shown in FIG. 3A) spaced apart from each other and configured to support the first end 102A of the component 102. In the illustrated embodiment of FIGS. 2 and 3A, the first support structure 106 includes two first rollers 128, 130. In other embodiments, the first support structure 106 may include three or more first rollers.

Each first roller 128, 130 is mounted on the corresponding first axle 122, 124. For example, the first roller 128 is mounted on the first axle 122 and the first roller 130 is mounted on the first axle 124 (as illustrated in FIG. 3A). Further, each first roller 128, 130 is positioned between the pair of first transverse members 114, 116 of the first pedestal 110. Specifically, the pair of first transverse members 114, 116 defines a first cavity 132 (shown in FIG. 2) therebetween, such that the at least two first rollers 128, 130 extend at least partially within the first cavity 132. Further, in some embodiments, a diameter DR1 of the at least two first rollers 128, 130 is larger than a diameter DA1 of the at least two first axles 122, 124. This may ensure proper improved support for the component 102 mounted on the at least two first rollers 128, 130. In some embodiments, the diameter DR1 of the at least two first rollers 128, 130 is at least twice of the diameter DA1 of the at least two first axles 122, 124.

FIG. 3B is a sectional view of the apparatus 100 taken along a line B-B shown in FIG. 2, according to an embodiment of the present disclosure. Referring again to FIGS. 2 and 3B, the second support structure 108 includes a second pedestal 140. The second pedestal 140 includes a second pedestal body 142 disposed on the platform 104. The second pedestal 140 further includes a pair of second transverse members 144, 146 (shown in FIG. 2) spaced apart from each other and extending from the second pedestal body 142 towards the direction away from the platform 104. Each second transverse member from the pair of second transverse members 144, 146 includes at least two second openings 148, 150 (shown in FIG. 4B). In the illustrated embodiment of FIGS. 2 and 3B, each second transverse member 144, 146 includes two openings 148, 150 arranged linearly to each other in the transverse direction (Y-Y) perpendicular to the axial direction (X-X). The second transverse members 144, 146 are transverse with respect to the platform 104.

The second openings 148, 150 in the spaced apart second transverse members 144, 146 are aligned with each other. In other words, each second opening 148, 150 of one second transverse member (i.e., the second transverse member 144) is aligned with each second opening 148, 150 of another second transverse member (i.e., the second transverse member 146). The second support structure 108 further includes at least two second axles 152, 154 (shown in FIG. 3B). In the illustrated embodiment of FIGS. 2 and 3B, the second support structure 108 includes two second axles 152, 154 arranged parallel to each other in the transverse direction (Y-Y). Each second axle 152, 154 passes and extends through the corresponding two second openings 148, 150 aligned with each other, such that each opposing end of each second axle 152, 154 is supported by one second transverse member from the pair of second transverse members 144, 146.

Specifically, each opposing end of each second axle 152, 154 is rotatably supported by at least one second bearing 156. The at least one second bearing 156 is disposed in the corresponding second opening from the at least two second openings 148, 150 of each second transverse member 144, 146. In other words, a first end of each second axle 152, 154 is rotatably supported inside the corresponding second opening from the at least two second openings 148, 150 of corresponding second transverse member by the at least one second bearing 156. Similarly, an opposing second end of each second axle 152, 154 is rotatably supported inside the corresponding second opening from the at least two second openings 148, 150 of another corresponding second transverse member by another at least one second bearing 156.

In the illustrated embodiment of FIGS. 2 and 3B, each end of the second axles 152, 154 is rotatably supported inside the second openings 148, 150 of each second transverse member 144, 146 by a pair of second bearings 156. In some embodiments, each end of the second axles 152, 154 may be rotatably supported inside the second openings 148, 150 of each second transverse member 144, 146 by a single second bearing 156. In some embodiments, the at least one second bearing 156 is a thrust bearing.

The second support structure 108 further includes at least two second rollers 158, 160 (shown in FIG. 3B) spaced apart from each other and configured to support the second end 102B of the component 102. In the illustrated embodiment of FIGS. 2 and 3B, the second support structure 108 further includes two second rollers 158, 160. In some embodiments, the second support structure 108 may include three or more second rollers.

Each second roller 158, 160 is mounted on the corresponding second axle 152, 154. For example, the second roller 158 is mounted on the second axle 152 and the second roller 160 is mounted on the second axle 154 (as illustrated in FIG. 3B). Further, each second roller 158, 160 is positioned between the pair of second transverse members 144, 146 of the second pedestal 140. Specifically, the pair of second transverse members 144, 146 defines a second cavity 162 (shown in FIG. 2) therebetween, such that the at least two second rollers 158, 160 extend at least partially within the second cavity 162. Further, in some embodiments, a diameter DR2 of the at least two second rollers 158, 160 is larger than a diameter DA2 of the at least two second axles 152, 154. This may ensure proper improved support for the component 102 mounted on the at least two second rollers 158, 160. In some embodiments, the diameter DR2 of the at least two second rollers 158, 160 is at least twice of the diameter DA2 of the at least two second axles 152, 154.

By supporting each opposing end of the at least two first axles 122, 124 on the pair of first transverse members 114, 116, load is evenly distributed across each first axle. Further, by supporting each opposing end of the at least two second axles 152, 154 on the pair of second transverse members 144, 146, load is evenly distributed across each second axle. With such even distribution of load across the at least two first axles 122, 124 and across the at least two second axles 152, 154, the axles of the apparatus 100 of the present disclosure may be subjected to significantly minimal bending under heavy loads. The relatively reduced bending of the at least two first axles 122, 124 and the at least two second axles 152, 154 may ensure consistent and optimal contact between the component 102 and the at least two first rollers 128, 130, and further between the component 102 and the at least two second rollers 158, 160. Hence, the apparatus 100 of the present disclosure may provide a balancing stand for improved and effective maintenance, repair, and inspection of a component (e.g., the component 102).

In some embodiments, the at least two first axles 122, 124 and the at least two second axles 152, 154 are electrically powered. For example, the at least two first axles 122, 124 and the at least two second axles 152, 154 may be driven by an electric motor (not shown). The motor may be a three-phase driving type motor so as to be able to change rotation direction of the at least two first axles 122, 124 and the at least two second axles 152, 154.

Additionally, in some embodiments, one or both of the first pedestal 110 and the second pedestal 140 are selectively movable in order to vary a distance therebetween. The selective movement of the one or both of the first pedestal 110 and the second pedestal 140 may enable mounting of components of different lengths on the apparatus 100. In some embodiments, the first pedestal 110 and/or the second pedestal 140 are electrically powered for selective movement thereof. For example, the first pedestal 110 and the second pedestal 140 may be driven by an electric motor or a stepper motor. Consequently, a rotational motion of the motor may be transformed into a linear motion to allow selective movement of the first pedestal 110 and the second pedestal 140. The selective movement of one or both of the first pedestal 110 and the second pedestal 140 (i.e., the movement in the axial direction X-X) may be achieved by a switch, lever, knob or similar mechanism. Such selective axial movement of the one or both of the first pedestal 110 and the second pedestal 140 may enable accommodation of different length components 102 on the apparatus 100. Further, as shown in FIG. 2, each of the first pedestal 110 and the second pedestal 140 is U-shaped. In other embodiments, each of the first pedestal 110 and the second pedestal 140 may be V-shaped, or H-shaped, depending on application requirements.

FIG. 4A is a front view of the apparatus 100 depicting the first support structure 106, in accordance with an embodiment of the present disclosure. Some parts of the apparatus 100, for example first rollers 128, 130, are not shown in FIG. 4A for illustrative purposes.

FIG. 4B is a rear view of the apparatus 100 depicting the second support structure 106, in accordance with an embodiment of the present disclosure. Some parts of the apparatus 100, for example second rollers 158, 160, are not shown in FIG. 4B for illustrative purposes.

It should be noted that the first support structure 106 and the second support structure 108 are preferably identical to each other or mirror images of each other.

As shown in FIG. 4A and 4B, each of the pair of first transverse members 114, 116 and the pair of second transverse members 144, 146 includes a curved portion 168 and a pair of linear portions 166 parallel to each other and extending from opposing ends of the curved portion 168. The curved portion 168 of each of the pair of first transverse members 114, 116 and the pair of second transverse members 144, 146 has a hemispherical shape. In some embodiments, the curved portion 168 of each of the pair of first transverse members 114, 116 and the pair of second transverse members 144, 146 has a semi-elliptical shape. In other embodiments, the curved portion 168 of each of the pair of first transverse members 114, 116 and the pair of second transverse members 144, 146 may have a different shape, such as torispherical, depending on application requirements.

Various examples have been described, each of which comprise one or more combinations of features. It will be appreciated by those skilled in the art that, except where clearly mutually exclusive, any of the features may be employed separately or in combination with any other features and the invention extends to and includes all combinations and sub-combinations of one or more features described herein.

We claim:

1. An apparatus for supporting a component to aid manufacturing, assembly, maintenance or repair operations, the component having a first end and a second end opposite to the first end, the apparatus comprises:
a platform;
a first support structure mounted on the platform and configured to support the first end of the component, the first support structure comprising:
a first pedestal comprising a first pedestal body disposed on the platform and a pair of first transverse members spaced apart from each other and extending from the first pedestal body towards a direction away from the platform, wherein each first transverse member from the pair of first transverse members comprises at least two first openings, wherein the first openings in the spaced apart first transverse members are aligned with each other;
at least two first axles, wherein each first axle passes and extends through the corresponding two first openings aligned with each other, such that each opposing end of each first axle is supported by one first transverse member from the pair of first transverse members; and
at least two first rollers spaced apart from each other and configured to support the first end of the component, wherein each first roller is mounted on the corresponding first axle, wherein each first roller is positioned between the pair of first transverse members of the first pedestal; and
a second support structure mounted on the platform and configured to support the second end of the component, wherein the second support structure is spaced apart from the first support structure, the second support structure comprising:
a second pedestal comprising a second pedestal body disposed on the platform and a pair of second transverse members spaced apart from each other and extending from the second pedestal body towards the direction away from the platform, wherein each second transverse member from the pair of second transverse members comprises at least two second openings, wherein the second openings in the spaced apart second transverse members are aligned with each other;
at least two second axles, wherein each second axle passes and extends through the corresponding two second openings aligned with each other, such that each opposing end of each second axle is supported by one second transverse member from the pair of second transverse members; and
at least two second rollers spaced apart from each other and configured to support the second end of the component, wherein each second roller is mounted on the corresponding second axle, and wherein each second roller is positioned between the pair of second transverse members of the second pedestal;
wherein each opposing end of each first axle is rotatably supported by at least one first bearing, and wherein the at least one first bearing is disposed in the corresponding first opening from the at least two first openings of each first transverse member.

2. The apparatus of claim 1, wherein each opposing end of each second axle is rotatably supported by least one second bearing, and wherein the at least one second bearing is disposed in the corresponding second opening from the at least two second openings of each second transverse member.

3. The apparatus of claim 2, wherein the least one second bearing is a thrust bearing.

4. The apparatus of claim 1, wherein each of the pair of first transverse members and the pair of second transverse members comprises a curved portion and a pair of linear portions parallel to each other and extending from opposing ends of the curved portion.

5. The apparatus of claim 4, wherein the curved portion of each of the pair of first transverse members and the pair of second transverse members has a hemispherical shape.

6. The apparatus of claim 4, wherein the curved portion of each of the pair of first transverse members and the pair of second transverse members has a semielliptical shape.

7. The apparatus of claim 1, wherein each of the first pedestal and the second pedestal is U-shaped.

8. The apparatus of claim 1, wherein the pair of first transverse members defines a first cavity therebetween, such that the at least two first rollers extend at least partially within the first cavity.

9. The apparatus of claim 1, wherein the pair of second transverse members defines a second cavity therebetween, such that the at least two second rollers extend at least partially within the second cavity.

10. The apparatus of claim 1, wherein the at least two first axles and the at least two second axles are electrically powered.

11. The apparatus of claim 1, wherein one or both of the first pedestal and the second pedestal are selectively movable in order to vary a distance therebetween.

12. The apparatus of claim 11, wherein at least one of the first pedestal and the second pedestal are electrically powered for selective movement thereof.

13. The apparatus of claim 1, wherein the at least one first bearing is a thrust bearing.

14. The apparatus of claim 1, wherein a diameter of the at least two first rollers is larger than a diameter of the at least two first axles.

15. The apparatus of claim 1, wherein a diameter of the at least two second rollers is larger than a diameter of the at least two second axles.

16. The apparatus of claim 1, wherein the component is a component of a gas turbine engine.

17. The apparatus of claim 16, wherein the component is a rotor of the gas turbine engine.
